(19) United States
(12) Patent Application Publication
(10) Pub. No.: US 2006/0005438 A1
(43) Pub. Date: Jan. 12, 2006

(54) Vase-like carrier for long stem candy

(76) Inventors: Steven S. Chang, Walnut, CA (US); Sonia Y. Chang, Walnut, CA (US)

Correspondence Address: HOVEY WILLIAMS LLP, 2405 GRAND BLVD., SUITE 400, KANSAS CITY, MO, 64108, US

(21) Appl. No.: 10/710,394

(22) Filed: Jul. 7, 2004

(51) Int. Cl. G09F 1/00

(52) U.S. Cl. 40/124.09

(57) ABSTRACT

An inexpensive, aesthetically pleasing display assembly (10) is provided in the form of an upstanding carrier (12) supporting at least one comestible article (14) such as a multiple-piece simulated candy bouquet (15). The carrier (12) includes a pair of interconnected, angularly oriented panels (20, 22), with the panel (20) having an uppermost open mouth (72) and an elongated passageway (70). The simulated bouquet (15) comprises a plurality of candy pieces (16) each supported by an elongated stem (18). The bouquet stems (18) are inserted into passageway (70), and the panels (20, 22) are separated so as to form a stable, upstanding, self-supporting display assembly (10).

### BACKGROUND OF THE INVENTION

1. Field of the Invention

The present invention is broadly concerned with novel display assemblies in the form of an upstanding carrier preferably formed of angularly oriented paperboard panels, together with one or more comestible articles (e.g., candy) supported by the carrier. In more detail, the invention is concerned with such display assemblies, as well as the improved display carrier and a blank used to form the carrier. The display assemblies of the invention are preferably decorated and provide novel, relatively inexpensive and aesthetically pleasing gifts for special occasions.

2. Description of the Prior Art

Those wishing to commemorate weddings, graduations or other special occasions, or desiring to lift the spirits of the ill, often send candy or flowers to mark the occasion or illness. Traditionally, candy has been sent in box or bag form, while flowers may be in the form of bouquets or plants. These tributes, while of long standing acceptability, can be relatively expensive for the sender and may be deemed trite. Therefore, a less expensive and innovative type of tribute is often sought.

Candy bouquets have also been proposed in the past, which can be in the form of a plurality of individual, brightly colored and specially shaped candy pieces each supported by an elongated stem. The stems in such a candy bouquet are tied or otherwise affixed together and may be placed in a traditional glass or other type of vase. Additionally, it is known to place such candy bouquets within a heart-shaped pocket card for gift-giving purposes. However, simple candy bouquets or pocket card bouquets are not free standing and cannot be readily displayed by the recipient.

U.S. Pat. No. 4,910,913 describes a paper vase for flowers. U.S. Pat. No. 6,061,955 also describes a collapsible flower vase assembly.

### SUMMARY OF THE INVENTION

The present invention overcomes the problems outlined above and provides a display assembly in the form of an upstanding carrier including a pair of interconnected, angularly oriented panels each presenting a base and an upper end. At least one comestible article supported on an elongated stem is operatively coupled with one of the panels and oriented with the article above the panel upper end. Preferably, the dual-panel carrier display is configured so that one of the panels has an upper open mouth and an elongated pocket or passageway; in this fashion the supporting stem(s) of the comestible article(s) can be inserted into the open mouth and along the length of the passageway, to provide full support for the articles while maintaining the ability of the carrier to stand

The interconnected panels are preferably each of generally trapezoidal configuration with the lowermost panel bases being longer than the opposed upper ends. If desired, at least one of the panels may be imprinted with a region on a face thereof to receive a written inscription.

The display carrier is advantageously fabricated from a unitary blank of material such as paperboard. Such a blank comprises first, second and third trapezoidal sections each including a relatively long base edge, a relatively short top edge, and a pair of angularly oriented side edges extending between the ends of the base and top edges. The first and second trapezoidal sections are interconnected at and along a transverse common fold line, whereas the first and third sections are interconnected at and along a common side edge. The second section is foldable along the transverse common fold line to come into face-to-face relationship with the first section, thereby forming the desired stem-receiving passageway in one of the panels of the display carrier.

Another aspect of the present invention concerns a candy display assembly comprising at least one candy article supported on an elongated stem and a carrier including an elongated panel that presents a pocket in which the stem is received. The stem and pocket present respective lengths that are complementally dimensioned so that the stem is substantially received in the pocket. Preferably, pocket length is at least about two-thirds as long as the stem length.

### BRIEF DESCRIPTION OF THE DRAWINGS

FIG. 1 is a plan view of a paperboard blank used in the construction of the preferred display carrier of the invention;

FIG. 2 is an elevational view of a display carrier in accordance with the invention, illustrated with decorative indicia on the outer faces of the carrier panels;

FIG. 3 is an elevational view similar to that of FIG. 2, but illustrating the inner faces of the carrier panels, wherein one of the inner faces includes a region for receipt of an inscription;

FIG. 4 is a perspective view of a simulated bouquet of candy made up of a plurality of separate pieces of candy each supported on an elongated stem, the stems being secured together;

FIG. 5 is a perspective view of a completed display assembly in accordance with the invention, wherein the candy bouquet of FIG. 4 is inserted into one of the panels of the display carrier; and

FIG. 6 is a view similar to that of FIG. 5, but illustrating the inner faces of the carrier panels.

### DETAILED DESCRIPTION OF THE PREFERRED EMBODIMENT

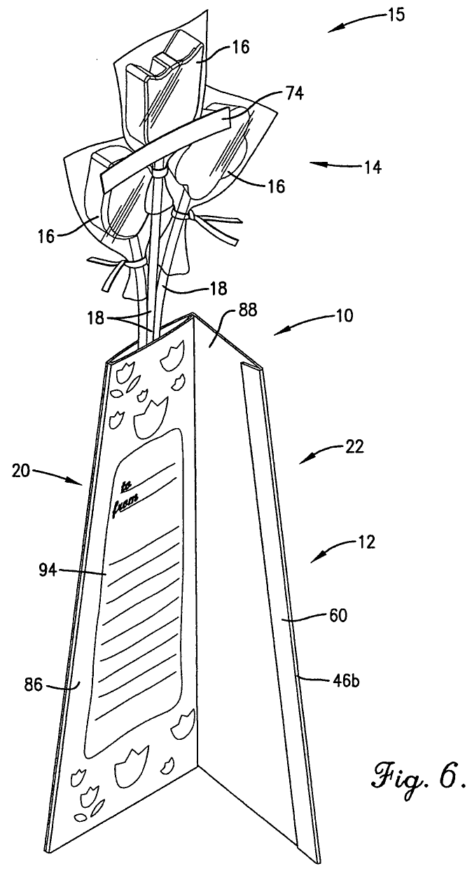

Turning now to the drawings, and particularly FIGS. 5 and 6, a display assembly 10 in accordance with the invention is illustrated. Broadly speaking, the assembly 10 includes an upstanding carrier 12 together with a plurality of comestible articles 14 (preferably arrayed as a simulated bouquet 15) supported by the carrier 12. In the illustrated embodiment, the articles 14 are in the form of individual pieces of candy 16 each supported on an elongated stem 18.

In more detail, and considering first the carrier 12, it will be seen that the carrier is in the form of an upright body including a pair of interconnected, angularly oriented panels 20 and 22 of generally trapezoidal configuration. The panel 20 presents a relatively long lowermost base edge 24 and an upper, relatively shorter edge 26. Additionally, the panel 20 has corresponding, angularly oriented side edges 28 and 30 extending between the edges 24 and 26. In like manner, the panel 22 has an elongated lower base edge 32, a somewhat shorter upper edge 34 and corresponding angular side edges 36 and 38. The edges 28 and 36 are essentially coincident owing to the interconnection of panels 20, 22.

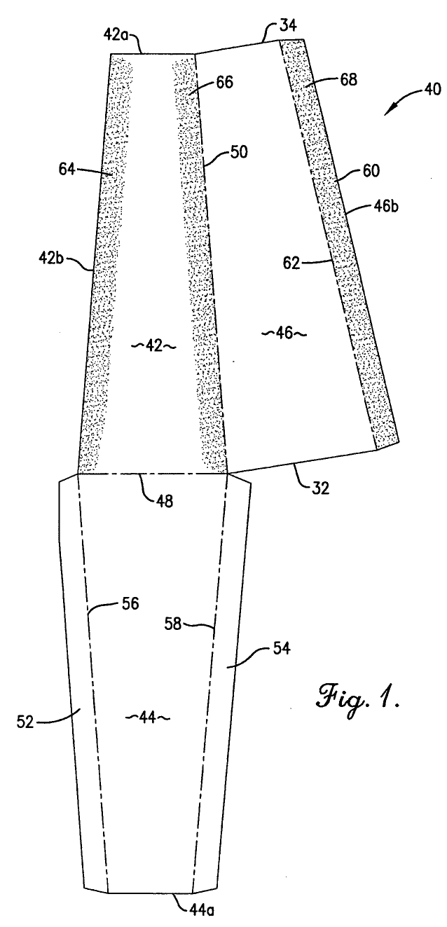

The display carrier 12 is preferably fabricated from a single, unitary blank 40 of paperboard or like material. As illustrated in FIG. 1, the blank 40 presents first, second and third generally trapezoidal sections 42, 44 and 46. The sections 42 and 44 are interconnected along a common fold line 48 and have opposed upper edges 42a and 44a. Additionally, the sections 42 and 46 are interconnected along a common fold line 50 and have outboard edges 42b and 46b remote from the fold line. The section 46 presents the bottom edge 32 and top edge 34 previously described.

The section 44 includes a pair of elongated, side marginal flaps 52 and 54 respectively secured along corresponding fold lines 56 and 58. The section 46 also has a flap 60 interconnected along a fold line 62 remote from section 42. The stippled regions of FIGS. 164, 66 and 68 represent regions for application of adhesive used during construction of the display carrier.

In order to construct the preferred carrier 12, the flaps 52, 54 are folded inwardly against the adjacent portions of section 44 and the section 44 is then folded about fold line 48 until the outer faces of the flap 52, 54 come into contact with the adhesive regions 64, 66. Next, the flap 60 is folded about line 62 until the adhesive carried thereby comes into contact with the adjacent region of section 46. It will be appreciated therefore that the fold line 48 ultimately becomes the bottom edge 24 of panel 20, and that the edges 42a and 44a cooperatively define the upper edge 26 thereof. Moreover, the juxtaposition of fold line 56 and edge 42b cooperatively define the side edge 30, whereas fold line 50 serves as the side edge 28. Finally, the fold line 62 defines the side edge 38 of panel 22.

It will also be appreciated that the face-to-face juxtaposition of trapezoidal sections 42 and 44 as described, with the adhesive interconnection of the flaps 52, 54 to section 42, creates an elongated pocket or passageway 70 extending along the length of panel 20; this passageway terminates at upper edge 26 with an open mouth 72.

Those skilled in the art will appreciate that the principles of the present invention are also applicable to various other carrier designs and configurations. For example, the panels need not be superposed or have the same shape. That is to say, it is entirely within the ambit of the present invention to provide panels having different shapes. The principles of the present invention also encompass other forms of interconnection between the panels. For example, the panels may alternatively be swingably connected along non-vertical junction (e.g., a hinge may alternatively extend generally horizontally to interconnect the panels).

The candy pieces 16 and stems 18 are preferably configured so as to create simulated bouquet 15. To this end, each of the candy pieces 16 is supported on an elongated, tubular synthetic resin stem 18 which preferably has a length of at least about 6 inches. Additionally, and as best seen in FIG. 6, the central stem 18 is surmounted by a transversely extending rear reinforcing strip 74 (e.g., an adhesive transparent tape) which provides a backing for the candy pieces 16. In the form shown, it will be observed that each of the candy pieces 16 is individually encased within a flexible, bag-like wrapper 76 with a tie 78 at the base of each such wrapper for closure purposes. A band-like retainer 80 (e.g., an adhesive transparent tape) is secured to the stems 18 beneath the candy pieces 16, so as to interconnect the stems and enhance the bouquet simulation effect.

In use, the simulated bouquet 15 is inserted into panel 20, i.e., the stems 18 are inserted into mouth 72 and slid downwardly along the length of passageway 70 to thereby support the bouquet 15 with the candy pieces 16 above the upper edge 26 of the panel 20. At this point the panels 20 and 22 are separated so that they are angularly oriented and provide a stable base. The display carrier can then be placed upon any level support surface such as a table or counter, in order to provide a pleasing aesthetic effect. Most preferably, the passageway 70 and stems are complementally configured so that each of the stems is substantially received within the passageway 70 (e.g., about two-thirds of each stem 18 below the candy piece 16 is received in the passageway 70) and thereby concealed by the panel 22. Additionally, the stems 18 are preferably not all of the same length so that at least some of the candy pieces are at different vertical positions.

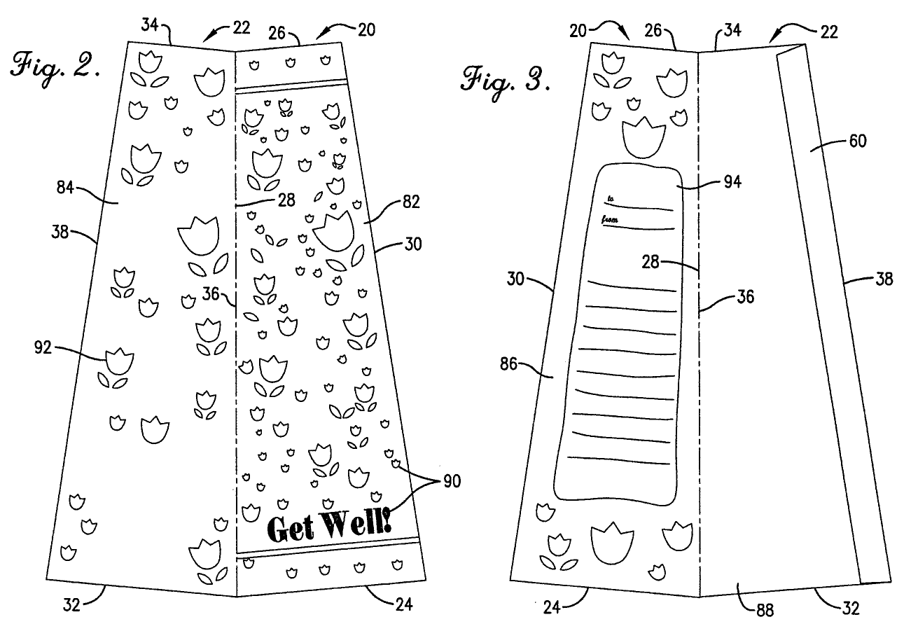

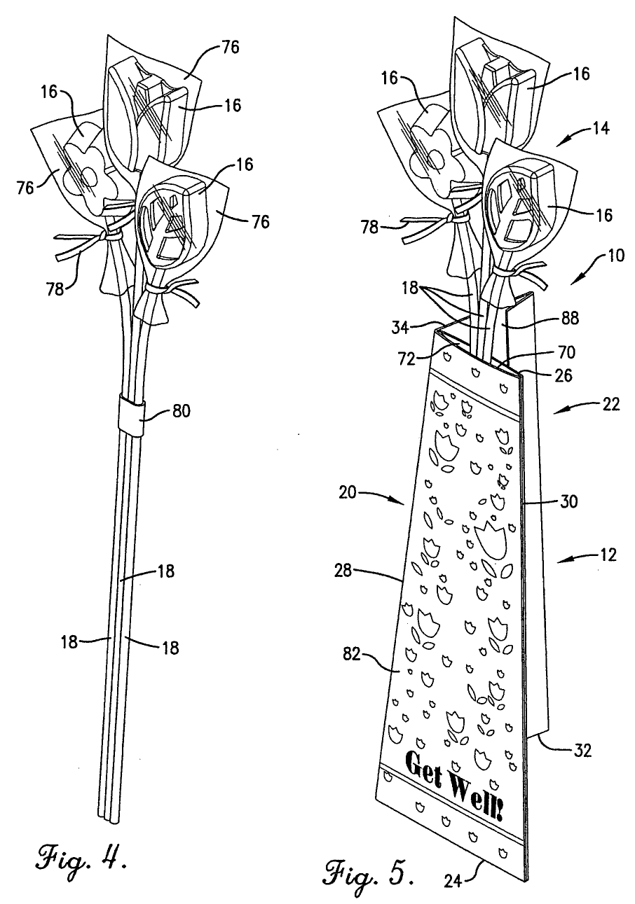

It is particularly noteworthy that the illustrated carrier 12 forms a greeting card, although the principles of the present invention are not limited to such a greeting card configuration. The panel 20 presents a front face 82 of the card, the panel 22 presents an opposite rear face 84 of the card (e.g., see FIG. 2), and the panels 20 and 22 cooperatively present opposed inner faces 86 and 88 of the card (e.g., see FIG. 3). The front face 82 is preferably provided with preprinted greeting indica 90 that corresponds with a particular occasion. In the illustrated embodiment, the occasion concerns wishing the recipient better health. In this regard, the indicia includes a textual sentiment in the form of the wording “GET WELL!”. The illustrated greeting indicia also includes a number of shapes in the form of flowers. The illustrated greeting card also includes preprinted greeting indicia 92 in the form of flowers. Although not essential to the invention, in preferred forms one of the inner faces 86 is provided with an inscription area 82 allowing the user to inscribe an personalized greeting or message.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

1. A display assembly comprising:
an upstanding carrier including a pair of interconnected, angularly oriented panels each presenting a base and an upper end; and
at least one comestible article supported on an elongated stem,
said stem operatively coupled with one of said panels to orient the comestible article above the one panel upper end.

2. The assembly of claim 1,
said one panel having an elongated passageway formed therein with a mouth adjacent said upper end,
said stem extending into and along the length of said passageway through said mouth.

3. The assembly of claim 1,
each of said panels being generally trapezoidal in plan configuration, with said base being longer than said upper end.

4. The assembly of claim 1,
at least one of said panels presenting a region on one face thereof to receive an inscription.

5. The assembly of claim 1,
said panels being interconnected along a fold line, such that the panels are superimposed when the carrier is folded,
said panels presenting a carrier front face and an opposite carrier back face,
said panels cooperating to present opposed inner faces,
said front face being provided with preprinted greeting indicia.

6. The assembly of claim 5,
said preprinted greeting indicia including a textual sentiment corresponding with a particular occasion.

7. The assembly of claim 6,
at least one of said inner faces including an inscription area operable to receive an inscribed message.

8. The assembly of claim 1,
said comestible article being candy.

9. The assembly of claim 1,
there being a plurality of said comestible articles, each supported on a respective elongated stem to simulate a bouquet.

10. The assembly of claim 1,
each of said stems having a length in excess of about 6 inches.

11. The assembly of claim 1,
said stem formed of tubular synthetic resin material.

12. The assembly of claim 1,
said carrier formed from a unitary blank of material.

13. The assembly of claim 12,
said material being paperboard.

14. A display carrier comprising:
a pair of interconnected, angularly oriented panels each presenting a base and an upper end,
one of said panels having an elongated passageway formed therein with a mouth adjacent said upper end,
said panels configured to permit said carrier to stand upright on said panel bases, and
said passageway adapted to receive articles to be displayed by the carrier.

15. The carrier of claim 14,
each of said panels being generally trapezoidal in plan configuration, with said base being longer than said upper end.

16. The carrier of claim 14,
at least one of said panels presenting a region on one face thereof to receive an inscription.

17. The carrier of claim 14,
said carrier formed from a unitary blank of material.

18. The carrier of claim 17,
said material being paperboard.

19. A blank adapted to form a carrier display, said blank comprising a unitary piece of material presenting first, second and third generally trapezoidal sections, each of said trapezoidal sections including a relatively long base edge, a relatively short top edge, and a pair of angularly oriented side edges extending between the ends of said base and said top edge, said first and second sections interconnected at a transverse common fold line, said first and third sections interconnected at a common side edge, said second section being foldable along said transverse common fold line to come into face-to-face relationship with said first section.

20. The blank of claim 19,
said second section having a pair of elongated flaps each connected to a side edge of the second section at a corresponding side edge fold line.

21. The blank of claim 19,
said third section having an elongated flap connected to the side edge of the third section remote from said first section.

22. A candy display assembly comprising:
at least one candy article supported on an elongated stem; and
a carrier including an elongated panel that presents a pocket in which the stem is received,
said stem and said pocket presenting respective lengths that are complementally dimensioned so that the stem is substantially received in the pocket.

23. The candy display of claim 22,
said pocket length being at least about two-thirds as long as the stem length.

24. The candy display of claim 22,
said carrier including a second elongated panel that is interconnected with the first-mentioned panel along a fold line, such that the panels are superimposed when the carrier is folded,
a first one of the panels presenting a front face, a second one of the panels presenting an opposite back face, and the panels cooperating to present opposed inner faces,
said front face being provided with preprinted greeting indicia.

25. The candy display of claim 24,
said preprinted greeting indicia including a textual sentiment corresponding with a particular occasion.

26. The candy display of claim 25,
at least one of said inner faces including an inscription area operable to receive an inscribed message.
